(19) United States
(12) Patent Application Publication
(10) Pub. No.: US 2005/0116385 A1
(43) Pub. Date: Jun. 2, 2005

(54) Method for producing a holding element

(76) Inventors: Bernd Schultheis, Schwabenheim (DE); Michael Muskalla, Paderborn (DE); Gerhard Hahn, Allenfeld (DE); Peter Nass, Mainz (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/502,262

(22) PCT Filed: Dec. 21, 2002
(86) PCT No.: PCT/EP02/14702

(30) Foreign Application Priority Data
Jan. 22, 2002 (DE) 10202404.9

(51) Int. Cl. B29C 47/02

(52) U.S. Cl. 264/259

(57) ABSTRACT

A method for producing a holding element on an edge region of a molded body made of a brittle material. The molded body is placed in a form tool that forms a charge cavity in the edge region of the molded body. The charge cavity is at least partially filled with a plastic material, and the molded body having the holding element formed thereon is then removed from the form tool. According to this invention, in order to optimize the production process, the molded body is held in the form tool by a clamping element. A section of the charge cavity is defined by the clamping element. A sealing element is applied to the molded body in a transition region between the charge cavity and the clamping element. The plastic material is introduced into the charge cavity by extrusion.

### BACKGROUND OF THE INVENTION

1. Field of the Invention

This invention relates to a holding element in an edge area of a molded body, and a method for producing the holding element, wherein the molded body which is of a brittle material is inserted into a molding tool, a material well in the edge area of the molded body is thus formed by the molding tool, the material well is at least partially filled by a plastic material, and then the molded body with the holding element formed on it is taken out of the molding tool.

2. Discussion of Related Art

A holding element for a cooking surface is known from German Patent Reference DE 197 03 543, wherein the cooking surface is formed as a molded body made of a brittle material. The holding element is of a duromeric material, which is fiberglass-reinforced for improving its characteristic material values.

A holder is described in German Patent Reference DE 196 15 371 A1, which is formed on a molded body by an injection-molding process. The material used is a thermoplastic material. In this method the plastic material shrinks greatly during cooling. So that no impermissibly high tensions are caused in the molded body, a shrinkage-absorbing element is used. This is inserted as a separate part into the mold during the injection-molding process and, when the workpiece is finished, is integrated into the holding element.

A method for producing extrusion-coated glass panes is known from European Patent Reference EP 98 112 258 A1.

### SUMMARY OF THE INVENTION

It is one object of this invention to provide a method of the type mentioned above but in which a holding element can be efficiently formed on a brittle molded body.

This object is achieved with a molded body maintained in the molding tool by a clamping element, wherein a section of the material well is delimited by the clamping element. A sealing element is placed on the molded body in a transition area between the material well and the clamping element, and the plastic material is placed into the material well and sets during an extrusion process.

In accordance with this invention, an extrusion process is used for producing the holding element. During this a clamping element, also called a pressure pad, is used for fixing the molded body in place. The sealing element ensures that the material well is securely sealed. It is thus possible to select the pressure applied to the molded body via the clamping element so that there is no danger of the material breaking.

Excess pressures can occur at times during the extrusion process. During this, excess plastic material escapes from the area between the clamping element and the molded body. Excess pressures can be prevented by using the sealing element.

In accordance with a preferred embodiment of this invention, an adhesive tape is glued as the sealing element to the molded body. The adhesive tape can be applied in an easy manner. Thus the adhesive surface can be designed so that it simultaneously takes over a sealing function.

If the sealing element has an elastically and/or plastically deformable effective layer which is deformed by the clamping element, it is possible to compensate irregularities close to the surface of the molded body by the sealing element, which is of particular interest should the molded body have a structured surface.

It is possible, for example, to dependably seal structured surfaces, in particular napped surfaces, as with molded bodies of glass-ceramic material.

A sufficiently dependable sealing can be achieved if the effective layer has a Shore hardness in a range between 40 and 80, preferably 50 to 70, Shore A, and/or the thickness of the material of the sealing element is selected to lie in a range of 0.1 to 0.5 mm, preferably in a range of 0.2 to 0.4 mm.

Good sealing can be achieved if the sealing element is partially displaced into the area of the material well. Thus it is possible to assure generous tolerances for the exactness of the application of the sealing element.

In accordance with this invention, the material well is filled with a fiberglass-reinforced duromeric material. The holding element produced by this material is particularly suited for framing cooking surfaces which are temperature-resistant and dimensionally stable and scratch-proof.

Following the removal of the molded body from the molding tool, the sealing element can be removed, depending on the product requirements, or can remain on the molded body. If it remains, it is necessary to select the properties of the material so that they meet the use requirements of the molded body.

It is possible to achieve good manufacturing results if the width of the sealing element, extension of the sealing element in the direction of the connecting plane of the sealing element with the molded body, is selected to lie within a range of 10 to 25 mm, preferably in a range of 12 to 18 mm.

The sealing element must also be capable of absorbing the manufacturing conditions during the manufacturing process. It is thus possible in accordance with this invention to provide the sealing element with a temperature resistance greater than 160° C. The danger of excess pressure is prevented if the distance of the sealing element from the edge of the molded body is selected to lie in a range between 0 and 10 mm, preferably in a range between 1 and 5 mm.

The holding element can be formed in the shape of a frame, for example, and can completely surround the molded body. Then the sealing element is positioned to extend around the molded body.

### BRIEF DESCRIPTION OF THE DRAWINGS

This invention is explained in view of an exemplary embodiment represented in the drawings, wherein:

FIG. 1 shows a fastening arrangement with a holding element and a molded body in a lateral and partial view, and

FIG. 2 shows the fastening arrangement represented in FIG. 1 in a manufacturing tool in a lateral view and in section.

### DESCRIPTION OF PREFERRED EMBODIMENTS

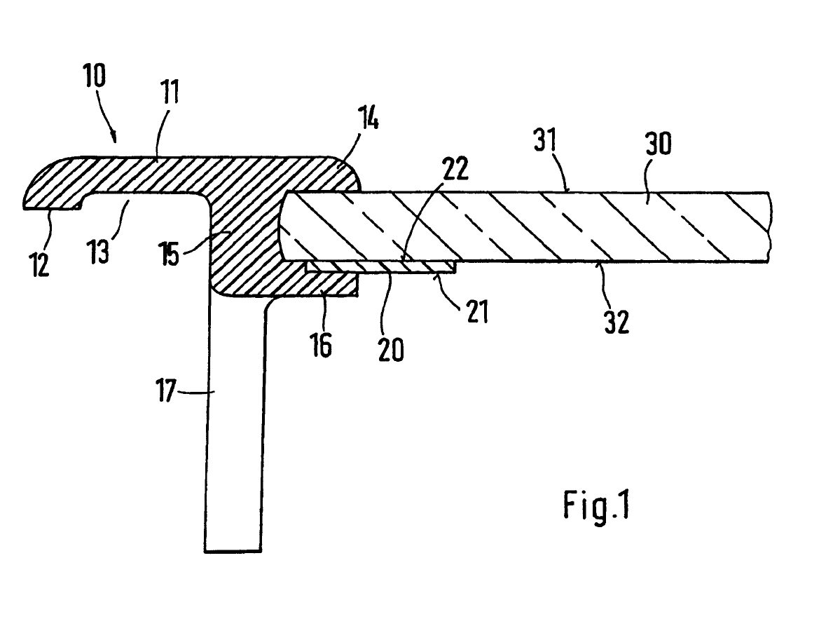

A molded body 30, such as a cooking surface, is represented in FIG. 1. The molded body 30 includes a brittle material, such as glass, a glass-ceramic or ceramic material. It is embodied in the form of a plate, which is surrounded by a holding element 10 on its edge. Here, the holding element 10 encloses the edge all around. Thus, a leg 14 of the holding element 10 rests on the top 31 of the molded body. A support element 16 extends parallel with the leg 14, which supports the molded body from below and is placed on its underside 32. The leg 14 is connected with the support element 16 by a strip 15. The strip 15 covers the outer edge area of the molded body 30. The strip 15 is extended by at least one fastening section 17. The fastening section 17 projects well beyond the support element 16.

As shown in FIG. 1, the support element 16 is supported in a partial area via a sealing element 20 on the underside 32 of the molded body 30. The sealing element 20 is embodied as an adhesive tape and has an adhesive layer 22, by which it is glued to the underside 32 of the molded body. An effective layer adjoins the adhesive layer 22 and is made of an elastically yielding material. The function of the sealing element 20 will be explained in greater detail later.

The leg 14 of the holding element 20 makes a transition into a protrusion 12 via a support section 11. The protrusion 12 releases a horizontal section of the support section, which results in a sealing receptacle 13. In the installed state the protrusions 12 is supported on a work plate. The portion of the arrangement located in the area of the strip 15 and the fastening section 17 is inserted into a recess of the work plate. A seal is inserted into the sealing receptacle 13 for sealing the surface of the work plate against the recess.

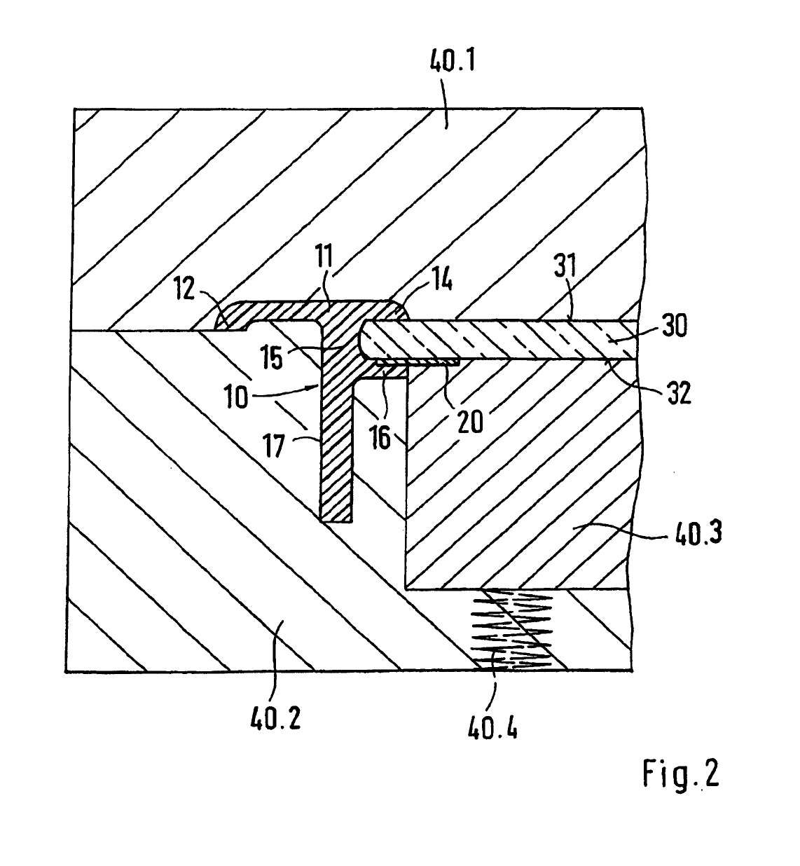

The process for the manufacture of the molded body 30 with the holding element 10 formed on it will be described with reference to FIG. 2.

A mold with two partial work molds 40.1 and 40.2 is shown in FIG. 2. The lower partial work mold 40.2 has an adjusting body 40.3 that can be displaced in the vertical direction by guides. The adjusting body 40.3 can be clamped by clamping elements 40.4 in the direction of its displacement degree of freedom. For forming the holding element 10, first the sealing element designed as an adhesive tape is glued to the underside 32 of the molded body 30. Subsequently the molded body 30 is placed into one of the two partial work molds 40.1, 40.2. Then, the second partial work mold 40.1, 40.2 is placed on it and the mold is closed. Subsequently, the adjusting body 40.3 is linearly displaced until it is seated with its adjusting face against the underside 32 of the molded body 30. Together with the two partial work molds 40.1 and 40.2, the adjusting body 40.3 encloses a material well located in the edge area of the molded body 30. The sealing element 20 extends into the area of the material well. At the same time, the sealing element 20 also projects so far inward that the adjusting body 40.3 can be supported flush on it. This results in a seal. The manufacture of the holding element is performed by an extrusion process. Thus, a thermosetting material, for example raw SMC material, is placed into the material well. Following the placement of this material and the closing of the two partial work molds 40.1, 40.2, a pressure is built up in the mold which causes the shaping of the holding element 10. The sealing element 20 prevents material from being pushed by excess pressure into the area between the underside 32 of the mold body 30 and the contact surface of the adjusting body 40.3. This effect then causes breakage of the brittle molded body 30 if an impermissible large amount of plastic material is pressed out. The sealing element 20 prevents this excess pressure. A certain amount of unevenness of the molded body 30 in the area of its underside 32 can be compensated by the effective layer used for the sealing element 20, which is embodied to be elastically yielding. In particular, it is possible to even out structured, for example napped undersides 32 of the molded body. Undersides 32 thus structured are used in cooking surfaces, for example.

Following a typical setting time of 2 to 3 minutes, the mold is opened and the finished part can be removed. The adhesive tape is partially pressed in during the manufacturing process. The projecting, still visible portion can either be removed thereafter, or can possibly also be left on the underside 32. Thus the outlay for finishing is clearly reduced. However, care should be taken that the sealing element 20 has the required characteristic material values in order to prevent waste or a visual interference. Thus the sealing element 20 can possibly have a definite transparency, temperature resistance or dimension.

1. A method for manufacturing a holding element in an edge area of a molded body, wherein the molded body is of a brittle material inserted into a molding tool, wherein a material well in the edge area of the molded body is formed by the molding tool, the material well is at least partially filled by a plastic material, and then the molded body with the holding element formed on is taken out of the molding tool, the molded body (30) is maintained in the molding tool by a clamping element (40.3), a section of the material well is delimited by the clamping element (40.3), and a sealing element (20) is placed on the molded body (30) in a transition area between the material well and the clamping element (40.3), the method comprising:
placing the plastic material into the material well and setting the plastic material during an extrusion process;
partially displacing the sealing element (20) into the area of the material well; and
one of following removal of the molded body (30) from the mold maintaining the sealing element (20) on the molded body and after the holding element (10) has been formed on then partially removing the sealing element (20).

2. The method in accordance with claim 1, wherein an adhesive tape is glued as the sealing element (20) to the molded body (10).

3. The method in accordance with claim 2, wherein the sealing element (20) has at least one of an elastically deformable and plastically deformable effective layer, which is deformed by the clamping element (40.3).

4. The method in accordance with claim 3, wherein the effective layer has a Shore hardness in a range between 40 and 80, preferably 50 to 70, Shore A.

5. The method in accordance with claim 4, wherein the material well is filled with a fiberglass-reinforced duromeric material.

6. The method in accordance with claim 5, wherein a thickness of the material of the sealing element (20) is in a range of 0.1 mm to 0.5 mm, preferably of 0.2 mm to 0.4 mm.

7. The method in accordance with claim 6, wherein a width of the sealing element (20) in a direction of a connecting plane of the sealing element (20) with the molded body (30) is selected to be within a range of 10 mm to 25 mm, preferably of 12 mm to 18 mm.

8. The method in accordance with claim 7, wherein the sealing element (20) has a temperature resistance greater than 160° C.

9. The method in accordance with claim 8, wherein a distance of the sealing element (20) from an edge of the molded body (30) is selected to be in a range between 0 and 10 mm, preferably between 1 mm and mm.

10. The method in accordance with claim 9, wherein sealing element (20) extends around the molded body (30).

11. The method in accordance with claim 10 wherein the molded body has a holding element.

12. The method in accordance with claim 1, wherein the sealing element (20) has at least one of an elastically deformable and plastically deformable effective layer, which is deformed by the clamping element (40.3).

13. The method in accordance with claim 12, wherein the effective layer has a Shore hardness in a range between 40 and 80, preferably 50 to 70, Shore A.

14. The method in accordance with claim 1, wherein the material well is filled with a fiberglass-reinforced duromeric material.

15. The method in accordance with claim 1, wherein a thickness of the material of the sealing element (20) is in a range of 0.1 mm to 0.5 mm, preferably of 0.2 mm to 0.4 mm.

16. The method in accordance with claim 1, wherein a width of the sealing element (20) in a direction of a connecting plane of the sealing element (20) with the molded body (30) is selected to be within a range of 10 mm to 25 mm, preferably of 12 mm to 18 mm.

17. The method in accordance with claim 1, wherein the sealing element (20) has a temperature resistance greater than 160° C.

18. The method in accordance with claim 1, wherein a distance of the sealing element (20) from an edge of the molded body (30) is selected to be in a range between 0 and 10 mm, preferably between 1 mm and 5 mm.

19. The method in accordance with claim 1, wherein the sealing element (20) extends around the molded body (30).

20. The method in accordance with claim 1 wherein the molded body has a holding element.
